(19) United States
(12) Patent Application Publication
(10) Pub. No.: US 2014/0255622 A1
(43) Pub. Date: Sep. 11, 2014

(54) CUSTOMIZED BUILDING OPENING COVER

(71) Applicant: Ruth SMITH, Tecumseh, OK (US)

(72) Inventor: Ruth SMITH, Tecumseh, OK (US)

(21) Appl. No.: 13/784,966

(22) Filed: Mar. 5, 2013

(51) Int. Cl. E06B 9/24

(52) U.S. Cl. CPC E06B 9/24
USPC 428/7; 428/195.1

(57) ABSTRACT

A building opening cover comprising a sheet of material, where the sheet of material includes a front surface, a back surface, a pair of horizontal edges and a pair of vertical edges; an illustration on the front surface of the sheet of material; and a static electric charge to fasten the sheet of material to a building opening. The building opening cover may be used on a door or window. The cover also prevents excess light from passing through the windows to shade the interior room.

### BACKGROUND OF THE INVENTION

1. Field of the Invention

The present invention relates to a cover for window or door that enables a user to customize the look or image displayed.

2. Description of Related Art

Many people utilize some type of window covering as a way to block light and to maintain temperature within a building interior. Typical window coverings are blinds, curtains, screens, shades, shutters and the like. Blinds and shutters provide slatted covers that may be opened or collapsed to access the underlying window. Curtains are typically fabric coverings that drape in front of the window, and are drawn to the sides when not needed. The window coverings are made from a range of materials including plastic, wood, felt, fabric, etc.

Due to the variety of materials, the range in value also varies. For example, custom multilayered, window coverings made from thick durable materials are very expensive compared to cheap plastic coverings that typically allow more temperature fluctuation. This makes changing the type or style of window covering difficult to where once a person chooses their coverings they are usually in place for a long period of time. Decorative changes are not done often because of the expense involved to replace the covers.

Therefore, it would be desirable in the art to provide a window covering that is easy to install and replace as desired by a user. It would also be beneficial for the window covering to allow for customization by the user.

### SUMMARY OF THE INVENTION

In view of the foregoing disadvantages inherent in the prior art, the general purpose of the present invention is to provide a cover for the opening of a building, configured to include all of the advantages of the prior art, and to overcome the drawbacks inherent therein.

Accordingly, an object of the present invention is to provide a customized building opening cover as a way to display illustrations on a door or window.

Another object of the present invention is to provide a customized building opening cover which reduces the amount of light that passes through a window.

To achieve the above objects, in an aspect of the present invention, a building opening cover is described comprising a sheet of material, where the sheet of material includes a front surface, a back surface, a pair of horizontal edges and a pair of vertical edges; an illustration on the front surface of the sheet of material; and a static electric charge to fasten the sheet of material to a building opening. The building opening cover may be used on a door or window. The cover also prevents excess light from passing through the windows to shade the interior room.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a front view of a door and a customized building opening cover in accordance with an exemplary embodiment of the present invention; and

FIG. 2 depicts a front view of a customized building opening cover placed on a door in accordance with an exemplary embodiment of the present invention.

Like reference numerals refer to like parts throughout the description of several views of the drawings.

DETAILED DESCRIPTION OF THE DRAWINGS

The present invention relates to a cover for window or door that enables a user to customize the look or image displayed. The present invention provides a customized building opening cover as a way to embellish doors and windows. The customized building opening cover may provide an alternative shading means to reduce the amount light passing through the window. The customized building opening cover remains in place with static electricity for easy removal and relocation as desired by the user.

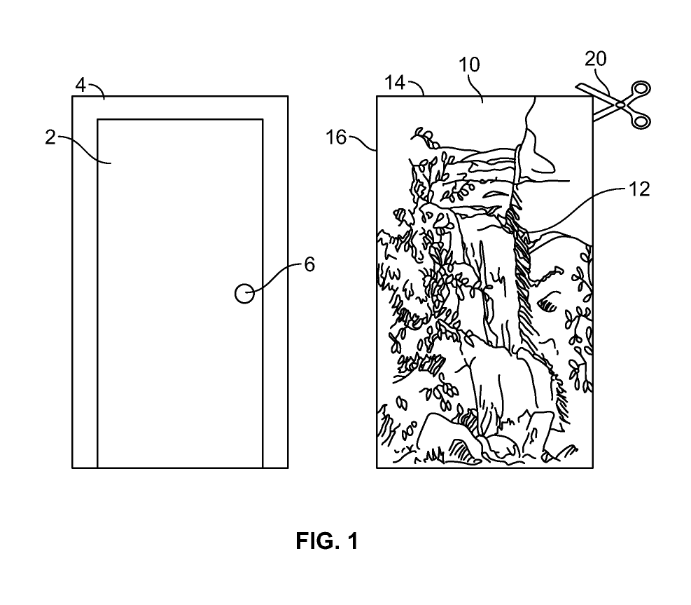

Turning now descriptively to the drawing, referring to FIG. 1, a perspective view of door 2 and a customized building opening cover 10 is shown in accordance with an exemplary embodiment of the present invention. The door 2 is includes a frame 4 and a handle 6. The customized building opening cover 10 is composed of a sheet of material that includes a pair of horizontal edges 14 and a pair of vertical edges 16. The edges 14, 16 may be sized to exactly fit the door 2 or a window. FIG. 1 illustrates using a pair of scissors 20 to size the sheet, but an X-acto™ knife, or a box cutter are all acceptable cutting means.

On the front surface of the sheet of material is an illustration 12. The illustration 12 may depict a design, scene, pattern, landscape, activity, color, shape, combination of pictures, seasonal theme or holiday them as picked and positioned by the user. When sizing the customized building opening cover 10, the user chooses how and where to position the illustration 12 so that it fits as desired on the door 2 or window.

The illustration 12 may vary on the amount of light allowed to pass through the sheet. For example, a darker or more detailed illustration 12 may allow less light or prevent light from passing, whereas a simple or light colored illustration 12 may allow more light to pass. The light gradient allowed to pass through the customized building opening cover 10 may provide a shading effect on windows. By shading the glass in the windows the user may forgo using blinds or curtains, as excess light is prevented from entering the interior room.

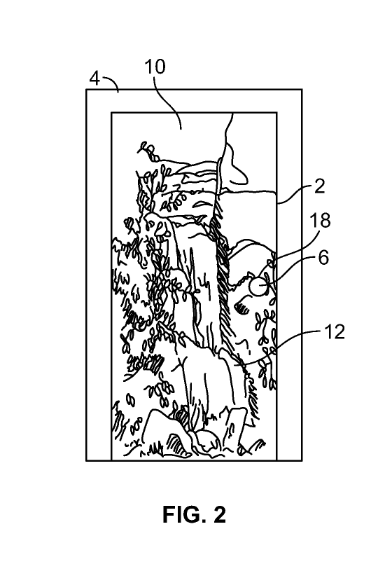

Referring now to FIG. 2 a front view of the door 2 with the customized building opening cover 10 is shown in accordance with an exemplary embodiment of the present invention. FIG. 2 illustrates how the custom building opening cover 10 is fit exactly to size of the door 2, including a cutout 18 to receive the handle 6. The illustration 12 may cover the entire door 2 or may simply cover a portion. For example, if the user only desires half of their door or window covered they may size the sheet accordingly. A quarter, third or any other proportion desired by the user may be sized for the door or window.

The back surface (not illustrated) ideally fastens to the door 2 or window with static electricity. This way sticky adhesives are eliminated which may leave residual material on the door 2 or window glass after use. Additionally, the static electric charge allows for quick and easy application and removal of the customized building opening cover 10, therefore providing more illustration 12 options for the user.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A building opening cover comprising:
a. a sheet of material, where the sheet of material includes a front surface, a back surface, a pair of horizontal edges and a pair of vertical edges;
b. an illustration on the front surface of the sheet of material; and
c. a static electric charge to fasten the sheet of material to a building opening.

2. The building opening cover according to claim 1, where the building opening is a door.

3. The building opening cover according to claim 1, where the building opening is a window.

4. The building opening cover according to claim 3, where the illustration allows a gradient of light to pass through the sheet of material thereby shading an interior room within the window.

5. The building opening cover according to claim 1, where the illustration is one of at least a design, scene, pattern, landscape, activity, color, shape, combination of pictures, holiday theme or seasonal theme.

6. The building opening cover according to claim 1, where the pair of horizontal edges and the pair of vertical edges are sized to exactly fit the building opening.
